(19) United States
(12) Patent Application Publication
(10) Pub. No.: US 2008/0187043 A1
(43) Pub. Date: Aug. 7, 2008

(54) METHOD AND APPARATUS FOR ENCODING/DECODING IMAGE USING ADAPTIVE QUANTIZATION STEP

(75) Inventors: Tae-gyoung AHN, Yongin-si (KR); Sung-kyu CHOI, Bucheon-si (KR); Jae-hun LEE, Yongin-si (KR); Chang-su HAN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/026,201

(22) Filed: Feb. 5, 2008

(30) Foreign Application Priority Data
Feb. 5, 2007 (KR) 10-2007-0011822

(51) Int. Cl. H04N 7/26

(52) U.S. Cl. 375/240.03; 382/238; 375/E07.126

(57) ABSTRACT

A method and apparatus for encoding and/or decoding an image are provided. The method of encoding an image includes: generating a prediction block that is an intra or inter prediction value of a current block; calculating a color difference between the current block and the generated prediction block; and, encoding the current block by adjusting a quantization step, based on the calculated color difference. In this way, color distortion in a restored image that can occur when a color of a current block is incorrectly predicted can be prevented.

### CROSS-REFERENCE TO RELATED PATENT APPLICATIONS

This application claims priority from Korean Patent Application No. 10-2007-0011822, filed on Feb. 5, 2007, in the Korean Intellectual Property Office, the disclosure of which is incorporated herein in its entirety by reference.

### BACKGROUND OF THE INVENTION

1. Field of the Invention

The present invention relates to a method and an apparatus for encoding and/or decoding an image, and more particularly, to a method of and apparatus for encoding and/or decoding an image by which the color difference between a current block and a prediction block that is an intra or inter prediction value of the current block is minimized.

2. Description of the Related Art

FIG. 1 is a diagram illustrating an apparatus for encoding an image according to conventional technology.

In an image compression method, such as motion picture experts group (MPEG)-1, MPEG-2, MPEG-4, H.264/MPEG-4 advance video coding (AVC), a picture is divided into a plurality of blocks, and encoding is performed in units of macroblocks.

Referring to FIG. 1, a motion estimation unit 102 and a motion compensation unit 104 perform inter prediction in which a prediction block of a current block is searched for in reference pictures. If the motion estimation unit 102 searches reference pictures stored in a frame memory 120 and finds a prediction block most similar to the current block, the motion compensation unit 104 generates a prediction block of the current block based on the found block.

In order to generate a prediction block of the current block, an intra prediction unit 106 performs prediction by using pixel values of pixels spatially adjacent to the current block, instead of searching reference blocks. According to an optimal intra prediction direction which is determined by considering a rate-distortion (R-D) cost, the pixel values of adjacent pixels are used as prediction values of the current block.

If the prediction block of the current block is generated in the motion compensation unit 104 or the intra prediction unit 106, the prediction block is subtracted from the current block, thereby generating a residue. A transform unit 108 performs discrete cosine transform (DCT), thereby transforming the generated residue into the frequency domain.

Coefficients in the frequency domain generated as a result of the DCT performed in the transform unit 108 are quantized by a quantization unit 110 according to a predetermined quantization step. Though loss in the original image occurs due to the quantization, the coefficients generated as a result of the DCT are not directly encoded, but are quantized to discrete integers, and then, encoding is performed. In this way, the coefficients can be expressed by using less bits.

The quantized coefficients are transformed to a bitstream through variable-length encoding in an entropy coding unit 112. In this case, information on the quantization step used in the quantization unit 110 is inserted into the bitstream.

The quantized coefficients are restored to a residue again through an inverse quantization unit 114 and an inverse transform unit 116. The restored residue is added to a prediction block, thereby being restored to a current block. The restored current block is deblocking-filtered, and then, is stored in the frame memory 120 in order to be used for intra/inter prediction of a next block.

In the related art apparatus for encoding an image, the processes for encoding a current block, described above, are performed in relation to each of Y, Cb and Cr values of pixels included in the current block. Human eyes are sensitive to Y that is a luminance value, but insensitive to Cb and Cr that are color difference values having high resolutions. Therefore, according to the related technology, Cb and Cr values are encoded with a number of pixels, the number being half the number of pixels for Y. For example, if it is assumed that the sampling frequency of Y is 4, even though the sampling frequency of Cb and Cr is set to 2 which is a half of that for Y, the picture quality is not greatly degraded.

However, in the process of encoding Cb and Cr values, the Cb and Cr values are quantized in the quantization unit 110, thereby causing a loss again. If due to this loss the current original block has a color different from that of a current block restored after encoding, then a distortion occurs in an image recognized by a user.

In addition, a restored block in which distortion occurs in the color is stored in the frame memory 120 and is used again when a next block is encoded. In other words, by using the restored block in which distortion occurs, intra or inter prediction is performed, and based on the prediction result, encoding is performed. Since the prediction is performed by using the block in which distortion occurs, the prediction is performed inaccurately, and the compression ratio of image encoding may be lowered.

In the case where the difference between colors that a user recognizes is not correctly reflected in the Cr and Cb values, the color distortion may appear greatly. For example, when the difference of Cb and Cr values between a current block and a prediction block of the current block is not big, but the difference of colors that a user recognizes exists, if this difference of colors is not sufficiently reflected in encoding the current block, a color distortion occurs in the image.

### SUMMARY OF THE INVENTION

The present invention provides a method of and apparatus for encoding and/or decoding an image capable of minimizing color distortion that can occur in a process of encoding an image.

An exemplary embodiment of the present invention also provides a computer readable recording medium having embodied thereon a computer program for executing the method.

According to an aspect of the present invention, there is provided a method of encoding an image including: generating a prediction block that is an intra or inter prediction value of a current block; calculating the color difference between the current block and the generated prediction block; and encoding the current block by a quantization step adjusted based on the calculated color difference.

The calculating of the color difference may include: transforming Y, Cb, and Cr values of pixels included in the current block and the prediction block into the Lab values; and calculating the distance between the current block and the prediction block on an ab plane based on the transformed Lab values.

The encoding of the current block may include: generating a residue that is the difference value between the current block and the prediction block; performing discrete cosine transform (DCT) of the generated residue; and quantizing the coefficients generated as the result of the DCT transform according to the quantization step adjusted based on the calculated color difference.

According to another aspect of the present invention, there is provided an apparatus for encoding an image including: a prediction unit generating a prediction block that is an intra or inter prediction value of a current block; a control unit calculating the color difference between the current block and the generated prediction block; and an encoding unit encoding the current block by a quantization step adjusted based on the calculated color difference.

The control unit may include: a color coordinate transform unit transforming Y, Cb, and Cr values of pixels included in the current block and the prediction block into the Lab values; and a difference determination unit calculating the distance between the current block and the prediction block on an ab plane based on the transformed Lab values.

The encoding unit may include: a differential unit generating a residue that is the difference value between the current block and the prediction block; a transform unit performing DCT transform of the generated residue; and a quantization unit quantizing the coefficients generated as the result of the DCT transform according to the quantization step adjusted based on the calculated color difference.

According to another aspect of the present invention, there is provided a method of decoding an image including: receiving a bitstream including data on a current block encoded by adjusting a quantization step of the encoding based on a color difference, after a prediction block which is an intra or inter prediction value of the current block is generated and the color difference between the current block and the prediction block is calculated; extracting the data on the current block and information on the adjusted quantization step from the received bitstream; and inverse-quantizing the data on the current block based on the information on the extracted quantization step.

According to another aspect of the present invention, there is provided an apparatus for decoding an image including: an entropy decoding unit receiving a bitstream including data on a current block encoded by adjusting a quantization step of the encoding based on a color difference, after a prediction block which is an intra or inter prediction value of the current block is generated and the color difference between the current block and the prediction block is calculated, and extracting the data on the current block and information on the adjusted quantization step from the received bitstream; and an inverse quantization unit inverse-quantizing the data on the current block based on the information on the extracted quantization step.

According to still another aspect of the present invention, there is provided a computer readable recording medium having embodied thereon a computer program for executing the methods of encoding and decoding an image.

### BRIEF DESCRIPTION OF THE DRAWINGS

The above and other features and advantages of the present invention will become more apparent from the following detailed description of exemplary embodiments thereof with reference to the attached drawings in which:

FIG. 1 is a diagram illustrating an apparatus for encoding an image according to conventional technology;

FIG. 2 is a diagram illustrating an apparatus for encoding an image according to an exemplary embodiment of the present invention;

FIG. 3 is a diagram illustrating an apparatus for calculating a color difference according to an exemplary embodiment of the present invention;

FIG. 4 is a diagram illustrating a method of calculating a color difference in a Lab color space according to an exemplary embodiment of the present invention;

FIG. 5 is a flowchart illustrating a method of encoding an image according to an exemplary embodiment of the present invention;

FIG. 6 is a diagram illustrating an apparatus for decoding an image according to an exemplary embodiment of the present invention; and

FIG. 7 is a flowchart illustrating a method of decoding an image according to an exemplary embodiment of the present invention.

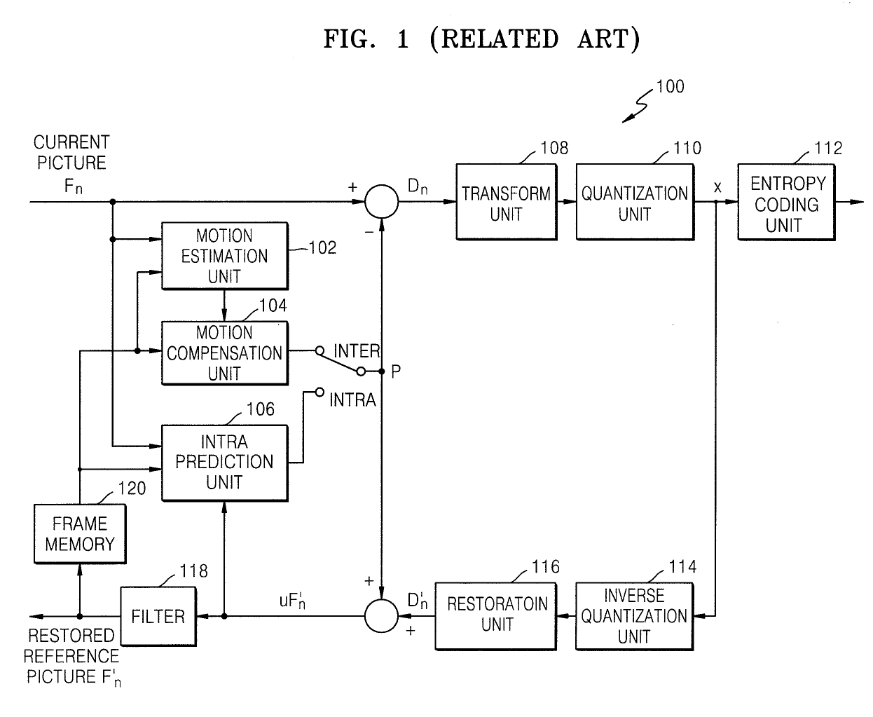

### DETAILED DESCRIPTION OF EXEMPLARY EMBODIMENTS OF THE INVENTION

The present invention will now be described more fully with reference to the accompanying drawings, in which exemplary embodiments of the invention are shown.

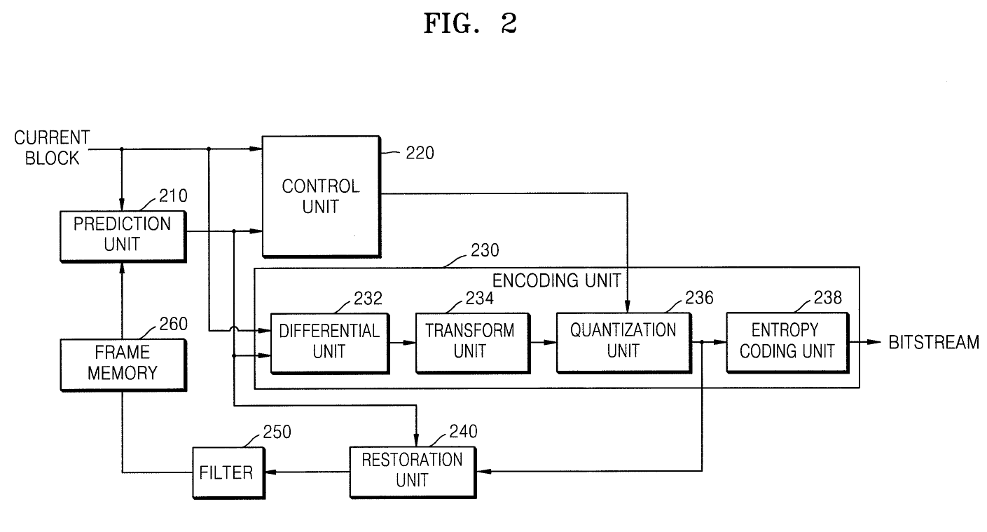

FIG. 2 is a diagram illustrating an apparatus for encoding an image according to an exemplary embodiment of the present invention.

Referring to FIG. 2, the apparatus for encoding an image according to the current exemplary embodiment includes a prediction unit 210, a control unit 220, an encoding unit 230, a restoration unit 240, a filter 250, and a frame memory 260. In particular, the apparatus for encoding an image corresponds to the control unit 220 and the encoding unit 230.

The prediction unit 210 receives an input of a current block, and performs intra and/or inter prediction, thereby generating a prediction block that is a predicted value of the current block. By using pixels of the current picture included in an area which is encoded before and stored in the frame memory 260, intra prediction is performed or by searching reference pictures, inter prediction is performed.

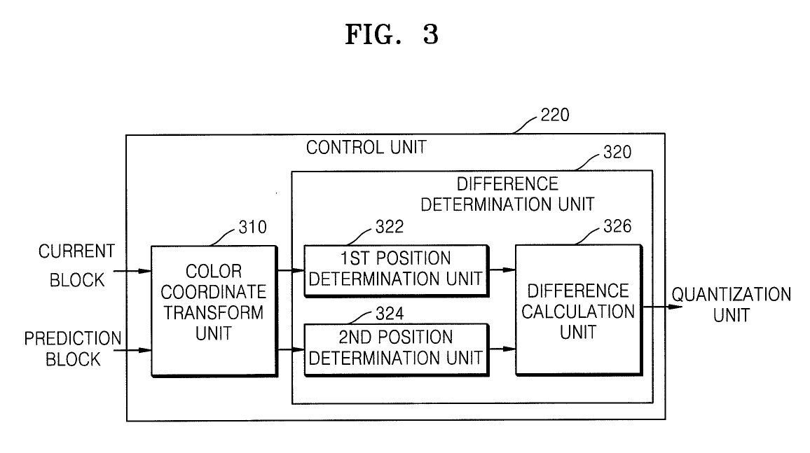

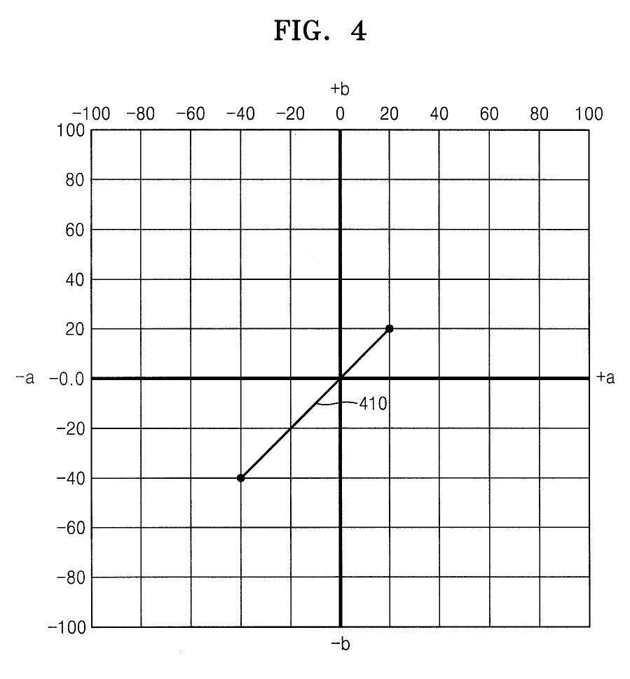

The control unit 220 receives the inputs of the current block and the prediction block generated by the prediction unit 210, and calculates a color difference between the two blocks. Pixels included in the current block and the prediction block have Y, Cb and Cr values, respectively, which are expressed in a YUV color space. Accordingly, based on the color values of the pixels, the color difference between the current block and the prediction block is calculated. This will be explained later with reference to FIGS. 3 and 4. A method of calculating a color difference illustrated in FIGS. 3 and 4 is merely an example of calculating the color difference between a current block and a prediction block, and that any method or apparatus for calculating the color difference between two blocks based on color values of pixels included in the current block and the prediction block can be used.

FIG. 3 illustrates an apparatus for calculating a color difference, i.e., the control unit 220, according to an exemplary embodiment of the present invention.

Referring to FIG. 3, the control unit 220 according to the current exemplary embodiment is composed of a color coordinate transform unit 310, and a difference determination unit 320. The difference determination unit 320 is composed of a first position determination unit 322, a second position determination unit 324, and a difference calculation unit 326.

The color coordinate transform unit 310 transforms Y, Cb and Cr pixel values in the YUV color space included in a current block and a prediction block, into coordinates of a different color space. The color difference may be calculated by directly using Y, Cb and Cr values of pixels included in the current block and the prediction block. However, in the current exemplary embodiment, the pixel values in the YUV color space are transformed to pixel values in an Lab color space.

Lab is a color space in which pixel values are classified into three channels, L, a and b, and is a color system internationally standardized by Commission Internationale de l'Eclairage (CIE) in 1976, based on an opponent color theory that red, green, blue and yellow cannot be simultaneously perceived in all colors. In the lab color space, L indicates the lightness of a pixel, a indicates the relationship between green and red in which a negative number means green and a positive number means red, and b indicates the relationship between blue and yellow in which a negative number means blue and a positive number means yellow.

In the Lab color space, a pixel value is determined by distinguishing a lightness component and a color component, and therefore, calculation of the color difference between a current block and a prediction block is easy. In other words, pixel values in the YUV color space are transformed into the pixel values of the Lab color space, and only color components, of the transformed pixel values, are compared, thereby calculating the color difference between the current block and the prediction block.

The Lab color space is merely an example of a color space for calculating a color difference, and a variety of color spaces, such as RGB, XYZ, YUV, and HIS, can be used for calculating the color difference between a current block and a prediction block.

The first position determination unit 322 determines the position of the current block in the color space, based on the pixel values of the current block transformed in the color coordinate transform unit 310. In the Lab color space, for example, the position of the current block on an ab plane illustrated in FIG. 4 is determined based on a and b values of the pixels included in the current block.

The position of the current block is determined by obtaining the average of a and b values of the pixels included in the current block. According to another exemplary embodiment, the position of the current block on the ab plane may be determined by selecting only a predetermined number of pixels from among the pixels included in the current block and obtaining the average of the a and b values of the selected pixels. It should be noted that any method of determining the position of the current block based on the a and b values of the pixels included in the current block can be used in order for the first position determination unit 322 to determine the position of the current block.

Like the first position determination unit 322, the second position determination unit 324 determines the position of the prediction block in a color space, based on the pixel values of the prediction block transformed in the color coordinate transform unit 310. In an Lab color space, for example, the position of the prediction block on the ab plane illustrated in FIG. 4 is determined based on the a and b values of the pixels included in the prediction block.

The position of the prediction block is determined by obtaining the average of all a and b values of the pixels included in the prediction block.

According to another exemplary embodiment, the position of the prediction block on the ab plane may be determined by selecting only a predetermined number of pixels from among the pixels included in the prediction block and obtaining the average of the a and b values of the selected pixels. As described above in relation to the first position determination unit 322, any method of determining the position of the prediction block based on the a and b values of the pixels included in the prediction block can be used in order for the second position determination unit 322 to determine the position of the prediction block.

The difference calculation unit 326 calculates the color difference between the current block and the prediction block based on the position of the current block in the color space determined in the first position determination unit 322, and the position of the prediction block in the color space determined in the second position determination unit 324. The calculated color difference is transmitted to the encoding unit 230, and is used to adjust a quantization step.

This will now be explained with reference to the example illustrated in FIG. 4. If the first position determination unit 322 determines that the position of the current block on the ab plane is a position in which a=−40 and b=−40, and the second position determination unit 324 determines that the position of the prediction block on the ab plane is such that a=20, and b=20, the color difference between the current block and the prediction block can be calculated as the length of a line segment connecting the two block positions, i.e., the distance between the two points. The longer the distance between the two points, the larger the color difference between the current block and the prediction block.

Referring again to FIG. 2, the encoding unit 230 performs encoding based on the current block, and the prediction block which is the value of the current block intra or inter predicted by the prediction unit 210.

The differential unit 232 subtracts the prediction block from the current block, thereby generating a residue. In order to increase the compression ratio only the residue is encoded.

The transform unit 234 transforms the residue generated in the differential unit 232 to a frequency component. By DCT transforming the residue generated in the differential unit 232, discrete cosine coefficients are generated.

The quantization unit 236 quantizes the coefficients generated in the transform unit 234 according to a predetermined quantization step. Though loss in the coefficients occurs due to the quantization, the coefficients are not directly encoded in the transform unit 234, and the coefficients are quantized to discrete integers, and then, encoding is performed such that the coefficients can be expressed by using less bits.

When the discrete cosine coefficients are quantized, the quantization unit 236 according to the current exemplary embodiment performs the quantization by adjusting the quantization step based on the color difference between the current block and a discrete block calculated in the control unit 220. If the color difference between the current block and the prediction block is large, i.e., the distance on the ab plane illustrated in FIG. 4 is long, the quantization step is adjusted to be small, thereby quantizing the discrete cosine coefficients. If the quantization step is small, the loss of the discrete cosine coefficients occurring in the quantization process becomes less, and thus the current block can be restored more accurately. Since a residue includes Y, Cb and Cr values in relation to each pixel, an exemplary embodiment may reduce the quantization step for only Cb and Cr values, and perform the quantization.

In the image compression methods, such as MPEG-1, MPEG-2, MPEG-4, H.264/MPEG-4 AVC, as described above, a quantization parameter is used to adjust a quantization step. Accordingly, a quantization step can be adjusted according to a method of reducing a QP value in order to reduce the quantization step.

Also, as in an H.264 standard, when a different QP value is applied to each discrete cosine coefficient and a quantization matrix is used for quantization, the quantization step can also be adjusted by adjusting each of QP values included in the quantization matrix based on the color difference calculated in the control unit 220.

The entropy coding unit 238 encodes the discrete cosine coefficients quantized in the quantization unit 236, thereby generating a bitstream. The generated bitstream also includes information on the quantization step used for the quantization in the quantization unit 236, that is, information on the QP or quantization matrix.

The restoration unit 240 inverse-quantizes the discrete cosine coefficients quantized in the quantization unit 236, and inverse-transforms the inverse-quantized discrete cosine coefficients, thereby restoring a residue. The restored residue is added to the prediction block generated in the prediction unit 210 and the current block is restored.

The restored current block is deblocking-filtered in the filter 250, and is then stored in the frame memory 260 in order to be used for prediction of a next block.

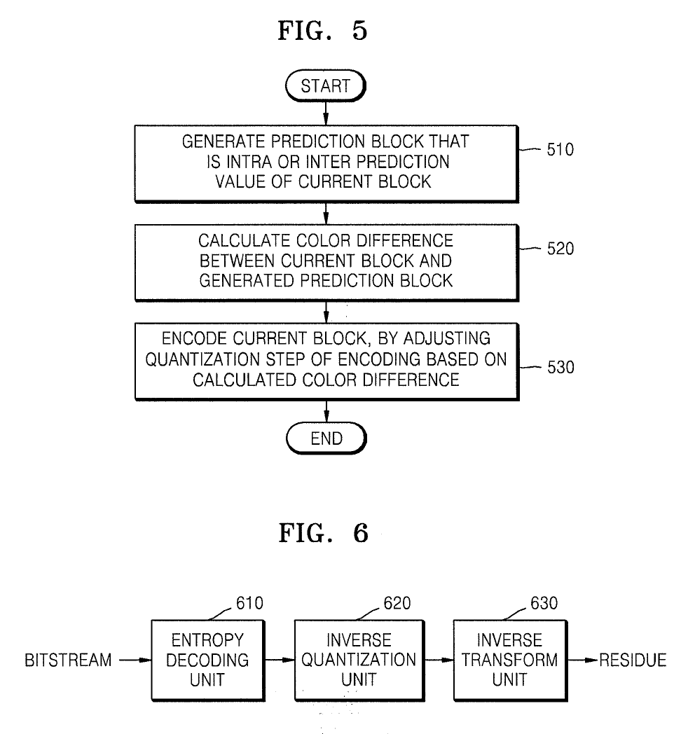

FIG. 5 is a flowchart illustrating a method of encoding an image according to an exemplary embodiment of the present invention.

Referring to FIG. 5, an apparatus for encoding an image according to an exemplary embodiment of the present invention generates a prediction block, which is an intra or inter predicted value of a current block in operation 510. The prediction block of the current block is generated by performing intra prediction by using pixels of the current picture included in a previously encoded area, or by performing inter prediction by using a reference picture.

In operation 520, the apparatus calculates the color difference between the current block and the prediction block generated in operation 510. The positions of the current block and the prediction block in a color space are determined based on the color values of the pixels included in the current block and the prediction block, respectively, and based on the determined positions, the color difference is calculated. The color values in a YUV color space may be transformed into color values of another color space, such as a Lab, and based on the transformed positions in the color space, the color difference can be calculated.

For example, FIG. 4 illustrates, the positions of the current block and the prediction block on the ab plane in the Lab color space, and by calculating the straight line distance between the determined positions, the color difference can be calculated.

In operation 530, the apparatus adjusts the quantization step of encoding, based on the color difference calculated in operation 520, thereby encoding the current block. The apparatus DCT transforms a residue obtained by subtracting the prediction block from the current block, and quantizes the discrete cosine coefficients generated as a result of the transform. When the quantization is performed, the quantization step is adjusted based on the color difference calculated in operation 520. If the calculated color difference between the current block and the prediction block is high, the quantization step is adjusted to be smaller, such that loss occurring in the quantization of the discrete cosine coefficients is reduced.

The quantization step may be adjusted by adjusting a quantization parameter, i.e., a QP value, or by adjusting each of the QP values included in a quantization matrix.

FIG. 6 is a diagram illustrating an apparatus for decoding an image according to an exemplary embodiment of the present invention.

Referring to FIG. 6, the apparatus for decoding an image according to the current exemplary embodiment comprises an entropy decoding unit 610, an inverse quantization unit 620, and inverse transform unit 630.

The entropy decoding unit 610 receives a bitstream including data on a current block encoded by an encoding method of the present invention. In other words, the color difference between the current block and the prediction block that is an intra or inter prediction value of the current block is calculated and then, by adjusting the quantization step based on the calculated color difference, the current block is encoded, and the data on the encoded current block is received.

The entropy decoding unit 610 extracts data on the current block and information on the quantization step from the received bitstream. The data on the current block is data on the residue obtained by subtracting the prediction block from the current block, and the information on the quantization step is information on the QP value and/or quantization matrix, which were inserted into the bitstream during encoding of the current block. The QP value and/or quantization matrix are values adjusted based on the color difference between the current block and the prediction block during encoding.

The inverse quantization unit 620 inverse-quantizes the data on the current block extracted in the entropy decoding unit 610. The inverse quantization is performed by multiplying the data on the residue, i.e., the discrete cosine coefficients of the residue, by the QP value extracted in the entropy decoding unit 610. If the information on the quantization step is included in the form of the quantization matrix in the bitstream, the inverse quantization is performed by multiplying the discrete cosine coefficients of the residue by QP values included in the quantization matrix, respectively.

The inverse transform unit inverse transforms the discrete cosine coefficients of the residue inverse-quantized in the inverse quantization unit 620, thereby restoring the residue. The residue that is the difference value between the current block and the prediction block is restored by performing inverse DCT transform with respect to the discrete cosine coefficients of the residue.

The restored residue is added to the intra or inter prediction block of the current block, and the current block is restored.

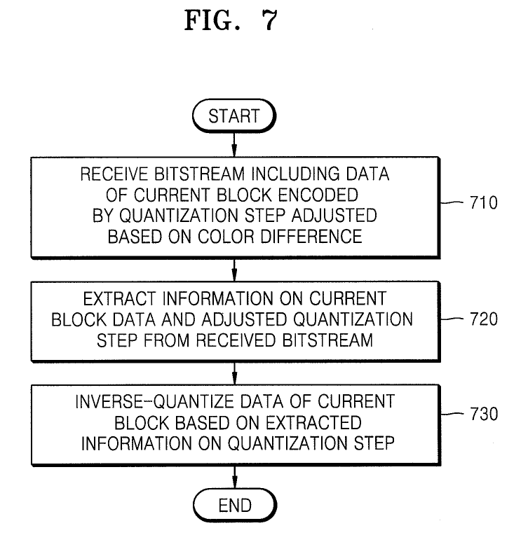

FIG. 7 is a flowchart illustrating a method of decoding an image according to an exemplary embodiment of the present invention.

Referring to FIG. 7, the apparatus for decoding an image according to an exemplary embodiment of the present invention receives a bitstream in operation 710. The bitstream includes data on a current block which is encoded by adjusting the quantization step based on the color difference calculated between the current block and a generated prediction block, which is an intra or inter prediction value of the current block.

The received bitstream includes data on the current block encoded by adjusting the QP value and/or quantization matrix based on the calculation result after calculating the positions of the current block and the prediction block in a color space based on the color values of the pixels included in the current block and the prediction block.

In operation 720, the apparatus extracts data on the current block and information on the quantization step from the bitstream received in operation 710.

The data on the current block is data on the residue obtained by subtracting the prediction block from the current block, and the information on the quantization step is information on the QP value and/or quantization matrix included in the bitstream.

In operation 730, the apparatus inverse-quantizes the data on the current block extracted in operation 720, based on the information on the quantization step also extracted in operation 720.

The inverse quantization is performed by multiplying the data on the residue, i.e., the discrete cosine coefficients of the residue, by the extracted QP value. If the information on the quantization step is included in the form of the quantization matrix in the bitstream, the inverse quantization is performed by multiplying the discrete cosine coefficients of the residue by QP values included in the quantization matrix, respectively. The inverse-quantized discrete cosine coefficients are inverse-transformed and the residue is restored. The restored residue is added to the intra or inter prediction block of the current block, and the current block is restored.

According to an exemplary embodiment of the present invention as described above, when the color difference between a current block and the prediction block occurs in a large scale because of incorrect prediction, by reducing the quantization step, the encoding is performed with a smaller quantization step. In this way, the current block can be restored accurately without a color distortion.

Also, according to exemplary embodiments of the present invention, the color difference between the current block and the prediction block is calculated in the Lab color space capable of reflecting the color difference that is felt by a user. Therefore, the color distortion felt by the user may be minimized.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope of the appended claims will be construed as being included in the present invention.

An exemplary embodiment of the present invention can also be embodied as a computer readable program stored on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable program is stored and executed in a distributed fashion.

What is claimed is:

1. A method of encoding an image comprising:
generating a prediction block that is an intra or inter prediction value of a current block;
calculating a color difference between the current block and the generated prediction block; and
encoding the current block by adjusting a quantization step, based on the calculated color difference.

2. The method of claim 1, wherein the calculating a color difference comprises:
transforming Y, Cb, and Cr values of pixels included in the current block and the prediction block into Lab values; and
calculating a distance between the current block and the prediction block on an ab plane based on the transformed Lab values.

3. The method of claim 2, wherein the calculating a distance comprises:
determining a position of the current block on the ab plane by obtaining an average of a values and b values from Lab values of the pixels included in the current block;
determining a position of the prediction block on the ab plane by obtaining an average of a values and b values from Lab values of the pixels included in the prediction block; and
calculating a distance between the current block and the prediction block on the ab plane, based on the determined position of the current block on the ab plane and the determined position of the prediction block on the ab plane.

4. The method of claim 1, wherein the encoding the current block comprises:
generating a residue that is a difference value between the current block and the prediction block;
performing discrete cosine transform (DCT) of the generated residue; and
quantizing the coefficients generated as a result of the DCT transform according to the quantization step adjusted based on the calculated color difference.

5. The method of claim 4, wherein the quantizing the coefficients comprises quantizing the coefficients by applying a quantization parameter (QP) adjusted based on the color difference.

6. The method of claim 4, wherein the quantizing the coefficients comprises quantizing the coefficients by applying a quantization matrix adjusted based on the color difference.

7. An apparatus for encoding an image comprising:
a prediction unit that generates a prediction block that is an intra or inter prediction value of a current block;
a control unit that calculates a color difference between the current block and the generated prediction block; and
an encoding unit that encodes the current block by adjusting a quantization step, based on the calculated color difference.

8. The apparatus of claim 7, wherein the control unit comprises:
a color coordinate transform unit that transforms Y, Cb, and Cr values of pixels included in the current block and prediction block into the Lab values; and
a difference determination unit that calculates a distance between the current block and the prediction block on an ab plane based on the transformed Lab values.

9. The apparatus of claim 8, wherein the difference determination unit comprises:
a first position determination unit that determines a position of the current block on the ab plane by obtaining an average of a values and b values from Lab values of the pixels included in the current block;
a second position determination unit that determines a position of the prediction block on the ab plane by obtaining an average of a values and b values from Lab values of the pixels included in the prediction block; and
a difference calculation unit that calculates a distance between the current block and the prediction block on the ab plane, based on the determined position of the current block on the ab plane and the determined position of the prediction block on the ab plane.

10. The apparatus of claim 7, wherein the encoding unit comprises:
a differential unit that generates a residue that is a difference value between the current block and the prediction block;
a transform unit that DCT transforms the generated residue; and
a quantization unit that quantizes the coefficients generated as a result of the DCT transform according to the quantization step adjusted based on the calculated color difference.

11. The apparatus of claim 10, wherein the quantization unit quantizes the coefficients by applying a QP adjusted based on the color difference.

12. The apparatus of claim 10, wherein the quantization unit quantizes the coefficients by applying a quantization matrix adjusted based on the color difference.

13. A method of decoding an image comprising:
receiving a bitstream including data on a current block encoded by adjusting a quantization step based on a color difference, after a prediction block which is an intra or inter prediction value of the current block is generated and the color difference between the current block and the prediction block is calculated;
extracting the data on the current block and information on the adjusted quantization step from the received bitstream; and
inverse-quantizing the extracted data on the current block based on the information on the extracted quantization step.

14. The method of claim 13, wherein the data on the current block is data on coefficients generated by DCT transforming a residue that is a difference value between the current block and the prediction block, and the information on the quantization step is information on a QP.

15. The method of claim 14, wherein the inverse-quantizing of the data comprises multiplying the coefficients by the QP.

16. An apparatus for decoding an image comprising:
an entropy decoding unit that receives a bitstream including data on a current block encoded by adjusting a quantization step based on a color difference, after a prediction block which is an intra or inter prediction value of the current block is generated and the color difference between the current block and the prediction block is calculated, and extracts the data on the current block and information on the adjusted quantization step from the received bitstream; and
an inverse quantization unit that inverse-quantizes the extracted data on the current block based on the information on the extracted quantization step.

17. The apparatus of claim 16, wherein the data on the current block is data on coefficients generated by DCT transforming a residue that is a difference value between the current block and the prediction block, and the information on the quantization step is information on a QP.

18. The apparatus of claim 17, wherein the inverse-quantization unit multiplies the coefficients by the QP.

19. A computer readable recording medium having embodied thereon a computer program for executing a method of decoding an image comprising:
receiving a bitstream including data on a current block encoded by adjusting a quantization step based on a color difference, after a prediction block which is an intra or inter prediction value of the current block is generated and the color difference between the current block and the prediction block is calculated;
extracting the data on the current block and information on the adjusted quantization step from the received bitstream; and
inverse-quantizing the extracted data on the current block based on the information on the extracted quantization step.
